(19) United States
(12) Patent Application Publication
(10) Pub. No.: US 2026/0138256 A1
(43) Pub. Date: May 21, 2026

(54) POWER TOOL INCLUDING A NON-CONTACT ROTATABLE ACTUATOR

(71) Applicant: MILWAUKEE ELECTRIC TOOL CORPORATION, Brookfield, WI (US)

(72) Inventors: William R. Kramer, Brookfield, WI (US); Paul F. Daily, Waukesha, WI (US); Alejandro M. Damonte Vegas, Menomonee Falls, WI (US); Kentez L. Craig, Milwaukee, WI (US); Jay M. Klubertanz, Hartford, WI (US)

(21) Appl. No.: 19/392,396

(22) Filed: Nov. 18, 2025

Related U.S. Application Data
(60) Provisional application No. 63/722,847, filed on Nov. 20, 2024.

(51) Int. Cl. B25F 5/02; B25F 5/00

(52) U.S. Cl. CPC B25F 5/02; B25F 5/001

(57) ABSTRACT

A power tool including a housing including a motor housing portion and a handle portion extending from the motor housing portion. The power tool further includes a motor disposed within the motor housing portion, a trigger located on a front side of the handle portion, and a dial assembly partially positioned within the housing above the trigger. The trigger is moveable axially along a trigger axis. The dial assembly is configured to change a torque setting of the power tool. The dial assembly includes a case coupled to the housing, a dial circuit board positioned within the case, and a dial surrounding the case. The dial circuit board includes a Hall effect sensor. The dial is rotatable about a dial axis orthogonal to the trigger axis and includes a magnet aperture. The magnet aperture is configured to receive a magnet, which is rotatable with the dial.

### RELATED APPLICATIONS

This application claims the benefit of U.S. Provisional Patent Application No. 63/722,847, filed Nov. 20, 2024, the entire content of which is hereby incorporated by reference.

### FIELD

This disclosure relates to a power tool.

### SUMMARY

Power tools described herein include a housing including a motor housing portion and a handle portion extending from the motor housing portion. The power tool further includes a motor disposed within the motor housing portion, a trigger located on a front side of the handle portion, and a dial assembly partially positioned within the housing above the trigger. The trigger is moveable axially along a trigger axis. The dial assembly is configured to change an operational characteristic of the power tool. The dial assembly includes a dial, a magnet coupled to the dial, and a dial circuit board. The dial circuit board includes a non-contact sensor configured to generate a signal representative of an orientation of the magnet. The dial is rotatable about a dial axis orthogonal to the trigger axis.

Power tools described herein include a housing, a motor within the housing, a trigger moveable axially along a trigger axis, and a dial assembly partially positioned within the housing. The dial assembly is configured to change an operational characteristic of the power tool. The dial assembly includes a dial rotatable about a dial axis orthogonal to the trigger axis. The dial includes a magnet coupled to the dial, the magnet rotatable with the dial, and a dial circuit board including a non-contact sensor configured to generate a signal representative of an orientation of the magnet.

Power tools described herein include a housing, a motor within the housing, a trigger for activating the motor, and a dial assembly partially positioned within the housing. The dial assembly is configured to change an operational characteristic of the power tool. The dial assembly includes a dial rotatable about a dial axis. The dial includes a magnet coupled to the dial, the magnet rotatable with the dial, and a non-contact sensor configured to generate a signal representative of an orientation of the magnet.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects of the disclosure will become apparent by consideration of the following detailed description and accompanying drawings.

### BRIEF DESCRIPTION OF THE DRAWINGS

FIG. 1 is a perspective view of a power tool, including a dial assembly, according to embodiments described herein.

FIG. 2 is a close-up perspective view of the power tool of FIG. 1 focused the dial assembly.

FIG. 3 is a side cross-sectional view of the dial assembly taken along a line 3-3 in FIG. 2.

FIG. 4 is an exploded view of the dial assembly of FIG. 1.

FIG. 5 is an exploded view of the dial assembly of FIG. 1.

FIG. 6 illustrates a block diagram of a controller for the power tool of FIG. 1 in accordance with embodiments described herein.

### DETAILED DESCRIPTION

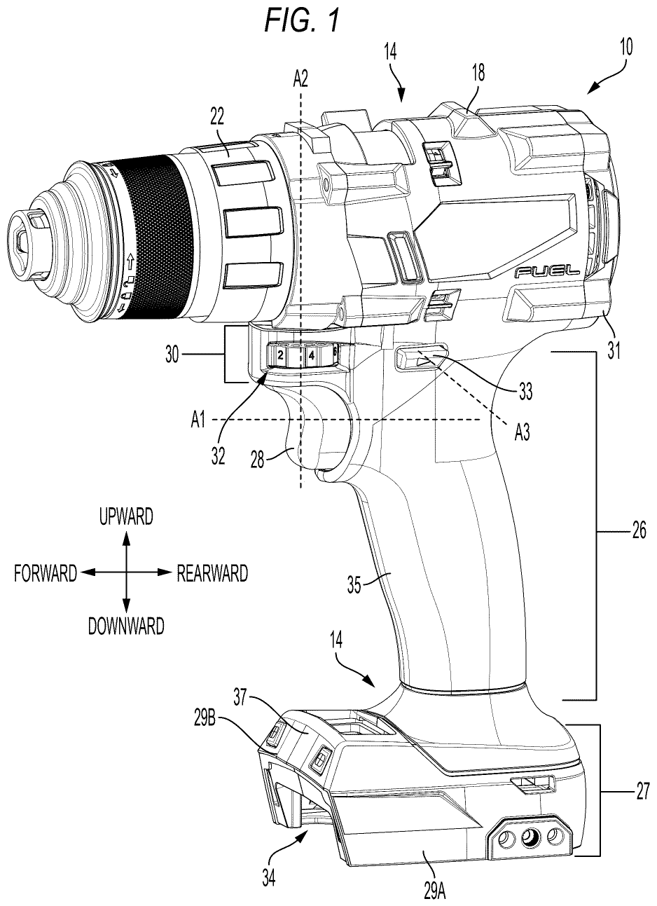

FIG. 1 illustrates a power tool 10 in the form of a rotary power tool (e.g., a drill/driver). The illustrated power tool 10 includes a housing 14 with a motor housing portion 18 enclosing a motor (e.g., a brushless DC motor; not shown), a front housing portion or case 22 coupled to or integral with the motor housing portion 18 (e.g., by a plurality of fasteners), a handle portion 26 extending downwardly from the motor housing portion 18, a foot portion 27 extending downward from the handle portion 26, and a rear housing portion 31 coupled to or integral with the motor housing portion 18 (e.g., by a plurality of fasteners). In some embodiments, the rear housing portion 31 is integral to the motor housing portion 18. The handle portion 26 includes a grip 35 that can be grasped by a user. In some embodiments, the foot portion 27 includes a work light 37 to selectively illuminate a workpiece. In the illustrated embodiment, the handle portion 26 and the motor housing portion 18 are defined by cooperating clamshell halves 29A, 29B.

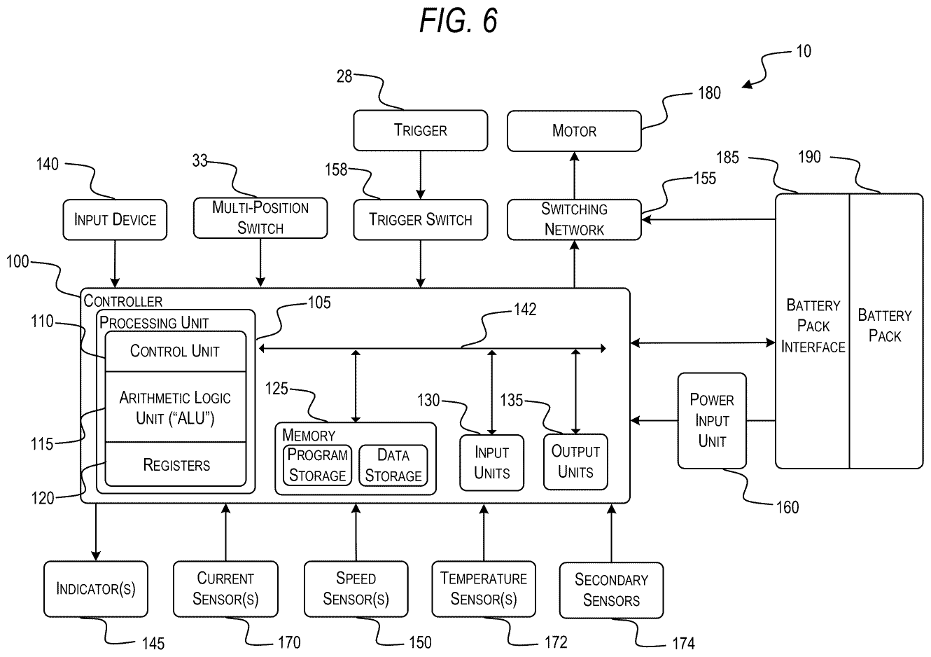

The power tool 10 has a battery pack receptacle 34 located at the foot portion 27. The battery pack receptacle 34 is configured to receive a battery pack (see FIG. 6), which provides power to the motor. In other embodiments, the power tool 10 may include a power cord for electrically connecting the power tool 10 to a source of AC power. As a further alternative, the power tool 10 may be configured to operate using a different power source (e.g., a pneumatic power source, etc.).

The power tool 10 further includes a trigger 28, a rotary actuator or dial assembly 32, and a multi-position switch 33. The trigger 28 is coupled to a front side of the handle portion 26 of the power tool 10 and is moveable along a trigger axis A1. In the illustrated embodiment, the dial assembly 32 is positioned above the trigger 28 and at least partially within a chin portion 30 of the power tool 10, located between the front housing portion 22 and the trigger 28. Additionally, the dial assembly 32 is positioned partially within and extends beyond the housing 14, and a portion of the dial assembly 32 is rotatable about a dial axis A2 orthogonal to the trigger axis A1. In the illustrated embodiment, the multi-position switch 33 is positioned rearward of the trigger 28 and is axially movable along an actuator axis A3. The multi-position switch 33 is also positioned partially within and extends beyond the housing 14. Movement of the trigger 28, the dial assembly 32, and the multi-position switch 33 are configured to alter the operational characteristics of the power tool 10.

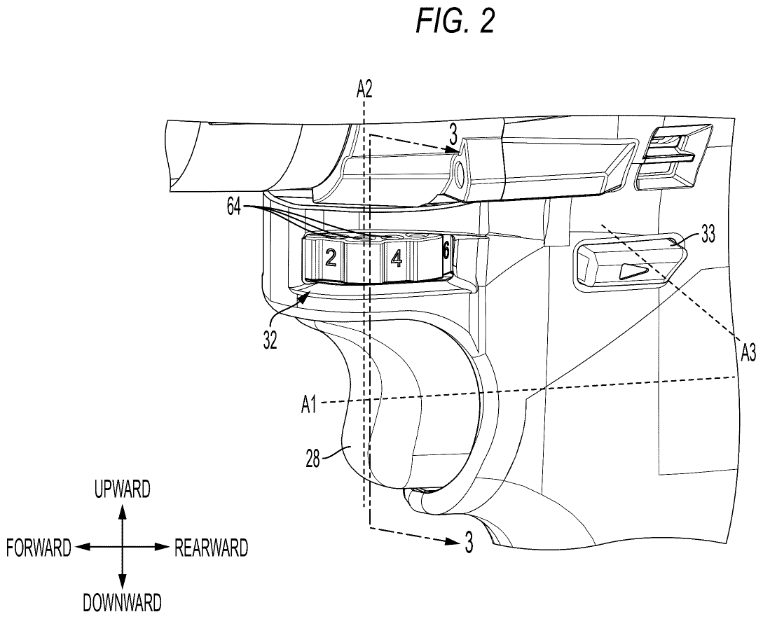

The power tool 10 includes an electronically-controlled clutch mechanism configured to receive an electronic torque setting and electronically (e.g., via motor control) and/or mechanically (e.g., via an adjustable slip condition of the clutch mechanism) limit the torque output of the power tool 10 based on the torque setting. In the illustrated embodiment, the power tool 10 includes a torque adjustment interface in the form of the rotary actuator or dial assembly 32. In some embodiments, the dial assembly 32 can be used to control a different parameter, such as a speed setting for the power tool 10. In use, rotation of one or more components of the dial assembly 32 around the dial axis A2 adjusts the torque setting of the power tool 10. In the illustrated embodiment, the dial axis A2 intersects the front housing portion 22 and the trigger 28. As illustrated in FIGS. 1 and 2, the dial assembly 32 is accessible from both lateral sides of the power tool 10. This allows the user to rotate the dial assembly 32 about the dial axis A2 (e.g., using the user's index finger) while grasping the grip 35 of the power tool 10 with the same hand, thus facilitating one-handed, ambidextrous operation of the power tool 10. In other embodiments, the dial assembly 32 is accessible from both lateral sides and the front of the power tool 10. The power tool 10 may include a set of indicators (not shown) that illuminate a work surface in one aspect. The set of indicators may be shadowless lights. It is further contemplated that the set of indicators change color or flash in various patterns that are associated with the torque setting (further described herein).

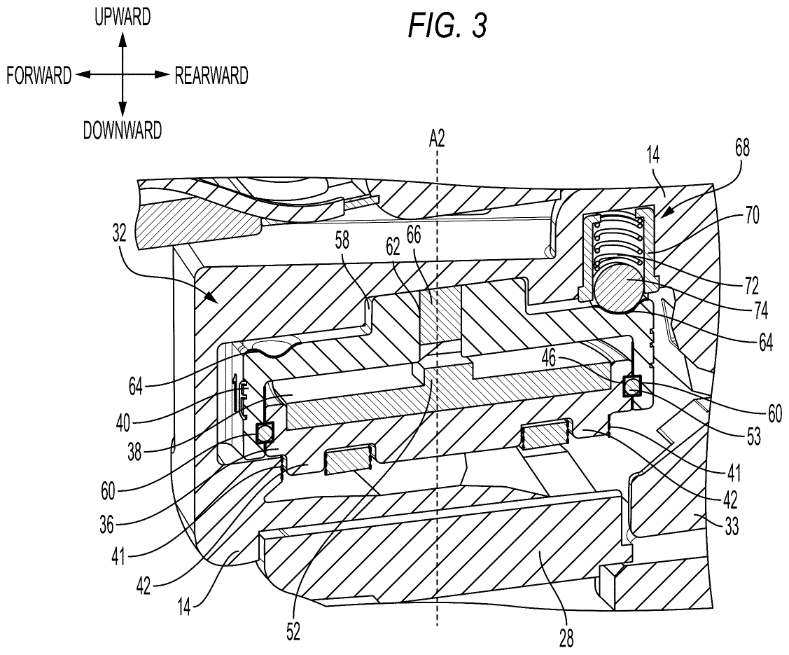

As illustrated in FIGS. 3, 4, and 5, the dial assembly 32 includes a case 36, a dial circuit board 38, and a dial 40. The case 36 is coupled to the housing 14 and includes a plurality of protrusions 42, an inner volume 44, and an outer circumferential recess 46. The plurality of protrusions 42 are formed on a bottom surface of the case 36 and are configured to be received by a plurality of corresponding openings 41 in the housing 14 (see FIG. 3). When the plurality of protrusions 42 are received in the corresponding openings 41, the case 36 is coupled to the housing 14 and is non-rotatable with respect to the housing 14. In other embodiments, the case 36 may be integrally formed on the housing 14.

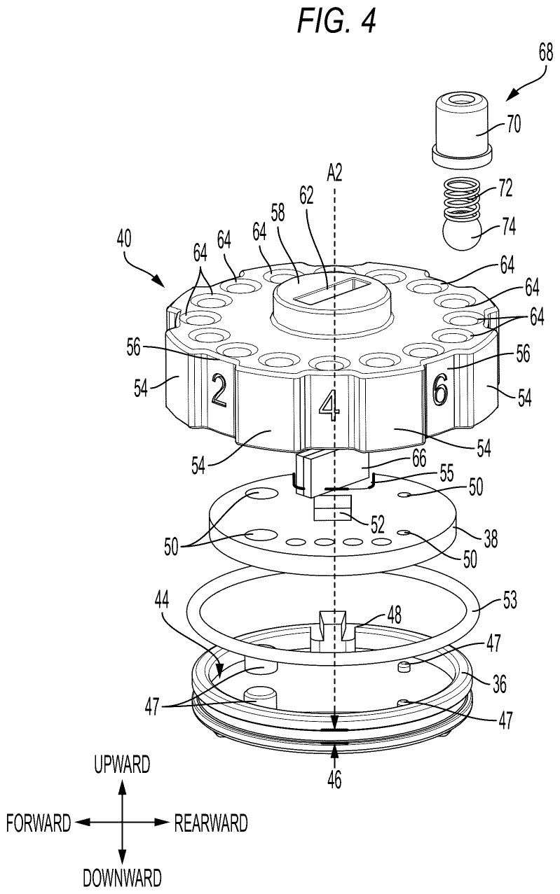

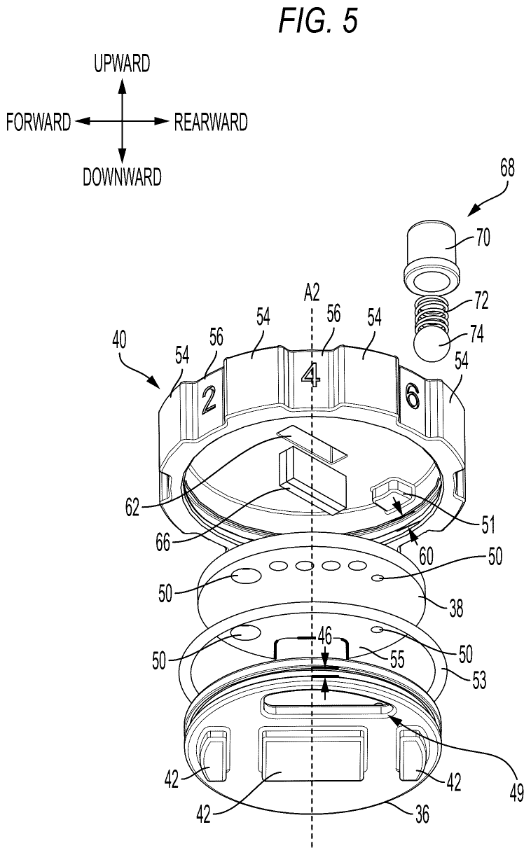

The inner volume 44 is shaped to receive the dial circuit board 38. As shown in FIGS. 4 and 5, the inner volume 44 includes a plurality of alignment posts 47, an end stop 48, and a wire outlet 49. The alignment posts 47 correspond with a plurality of alignment apertures 50 in the dial circuit board 38 to ensure that the dial circuit board 38 is installed in the desired orientation. In the illustrated embodiment, the alignment posts 47 are differently sized from one another. In other embodiments, the alignment posts 47 may be equally sized. In further embodiments, the alignment posts 47 may be omitted, and the shape of the inner volume 44 may only allow the dial circuit board 38 to be installed in the desired orientation. The end stop 48 extends outward from the inner volume 44 and selectively contacts a cam 51 formed on the dial 40 to limit the rotation of the dial 40 to a single full rotation or less. The wire outlet 49 is an opening in a bottom surface of the inner volume 44 to allow wires from the dial circuit board 38 to connect to another circuit board or component positioned within the power tool 10.

The outer circumferential recess 46 is formed on an outer surface of the case 36 and extends around the entire circumference. The outer circumferential recess 46 is configured to receive, for example, an O-ring 53, which seals the inner volume 44 from the surrounding environment when the dial 40 is installed. In other embodiments, the dial 40 may not surround the case 36 and instead may be positioned on top of the case 36. In that scenario, the recess 46 would be formed on the underside of the dial 40, so the O-ring 53 would contact to top surface of the case 36 when assembled. In a further embodiment, the O-ring 53 could be omitted.

With continued reference to FIGS. 3-5, the dial circuit board 38 has a substantially circular profile and is positioned in the inner volume 44 of the case 36. In other embodiments, the dial circuit board 38 may be square, rectangular, hexagonal, octagonal, or polygonal. The dial circuit board 38 includes at least one alignment aperture 50, a notch 55, and a non-contact sensor 52. As described above, the at least one alignment aperture 50 corresponds with the at least one alignment post 47 in the inner volume 44 to ensure the dial circuit board 38 is installed in a particular orientation. Additionally, the notch 55 is sized to receive the end stop 48 and also ensures proper alignment of the dial circuit board 38. In the illustrated embodiment, the non-contact sensor 52 is positioned in the center of the dial circuit board 38. Also, in the illustrated embodiment, the non-contact sensor 52 is a 3-Dimensional (“3D”) digital Hall effect sensor configured to generate a signal representative of the magnetic flux of at least one magnet and is configured to communicate with a controller 100 using a digital protocol, such as the I2C protocol. In the illustrated embodiment, the non-contact sensor 52 is within the inner volume 44 and is co-axial with the magnet 66.

The dial assembly 32 may include several alternate embodiments of the dial circuit board 38. In another embodiment, the non-contact sensor 52 may be positioned on the side of the dial circuit board 38 opposite to the magnet 66. In further embodiments, the dial circuit board 38 may be positioned outside the inner volume 44 of the case 36 and may be positioned above or below the dial 40. In one embodiment, the dial circuit board 38 may include a non-contact sensor 52 that is a 2D Hall effect sensor, a 1D Hall effect sensor, an analog Hall effect sensor, or a tunnel magnetoresistance (TMR) sensor. In another embodiment, the non-contact sensor 52 may communicate via an SPI protocol, a UART protocol, an analog voltage, or a PWM signal having a duty cycle. In some embodiments, the dial circuit board 38 may include more than one non-contact sensor 52. For example, the non-contact sensor 52 may be two 1D Hall effect sensors, which would each generate a signal corresponding to the strength of the magnetic field seen along each non-contact sensor's 52 axis of measurement. In another embodiment, the non-contact sensor 52 may be a single 2D or 3D Hall effect sensor positioned off-axis from the magnet 66 and may be used to determine the magnetic field angle of the magnet 66. In other embodiments, a non-contact sensor 52 may be a 3D Hall effect sensor that is only measuring magnetic flux along 2 of the 3 axes.

With continued reference to FIGS. 3-5, the dial 40 is positioned over the case 36 and is configured to be rotatable about the dial axis A2. In the illustrated embodiment, the dial 40 is substantially gear-shaped and includes the cam 51, a plurality of teeth 54, and a plurality of bottom lands 56 positioned between the plurality of teeth 54. As described above, the cam 51 selectively engages the end stop 48 to limit the rotation of the dial 40. In other embodiments, the dial 40 may include additional cams 51 to further reduce the range of rotation of the dial 40. In the illustrated embodiment, the plurality of bottom lands 56 includes debossed numerical indicators representative of the currently selected setting (e.g., a torque setting). In other embodiments, the bottom lands 56 may include embossed, printed indicators, or text-based indicators to represent the currently selected torque setting. In further embodiments, the bottom lands 56 may not include any indicators on the dial 40, but instead, the currently selected torque setting could be shown using a display or a plurality of LEDs. The teeth 54 and the bottom lands 56 provide additional leverage to the finger of the user to turn the dial 40 about the dial axis A2. In some embodiments, the dial 40 may instead be cylindrical or polygonal.

With continued reference to FIGS. 3-5, the dial 40 includes a shaft portion 58, an inner circumferential recess 60, a magnet aperture 62, and a plurality of detent recesses 64. The shaft portion 58 is formed on a top surface of the dial 40 and is received by a portion of the housing 14, as shown in FIG. 3. The shaft portion 58 supports the rotation of the dial 40 and defines the dial axis A2. The inner circumferential recess 60 is formed on an inner circumference of the dial 40 and is configured to receive a portion of the O-ring 53. When the O-ring 53 is received in both the outer circumferential recess 46 of the case 36 and the inner circumferential recess 60 of the dial 40, the inner volume 44 is sealed from the surrounding environment. As shown in FIGS. 4-5, the magnet aperture 62 is centrally formed on the dial 40 and is coincident with the dial axis A2. In the illustrated embodiment, the magnet aperture 62 is rectangular and is configured to receive a rectangular magnet 66. When the rectangular magnet 66 is in the magnet aperture 62, the rectangular magnet 66 is in line with the non-contact sensor 52 of the dial circuit board 38. In other embodiments, the magnet aperture 62 may be shaped differently (e.g., circular, square, hexagonal, octagonal, or polygonal) to receive differently shaped magnets 66. In further embodiments, the dial 40 may include more than one magnet aperture 62 to receive more than one magnet 66, and each magnet aperture 62 may be offset from the dial axis A2. In some embodiments, the magnet aperture 62 may be omitted and the magnet 66 may be coupled to the inner surface of the dial 40 via adhesives or a fastener. In the illustrated embodiment, the plurality of detent recesses 64 are formed on the top surface of the dial 40 and are equally radially spaced apart from one another. In another embodiment, the plurality of detent recesses 64 may be formed on the circumferential surface or on the interior of the dial 40. In further embodiments, the detents recesses may be unequally spaced apart on the dial 40. In use, the detent recesses 64 selectively receive a portion of a spring-loaded detent 68, as described in greater detail below.

In some embodiments, the dial assembly 32 may include magnetic shielding material to reduce the influence of outside magnetic flux on the non-contact sensor 52. In one example, the dial 40 may have a hollow cylinder of shielding material imbedded in the walls of the dial 40. In another example, the dial 40 may have a hollow cylinder of shielding material lining an interior of the dial 40. In a further example, the circular disks made of shielding material may be place above and/or below the dial assembly 32. Additionally, in some examples, one more of the above shielding material configurations may be used.

With continued reference to FIGS. 3-5, the power tool 10 further includes the spring-loaded detent 68 positioned within the housing 14 of the power tool 10. The spring-loaded detent 68 includes a detent casing 70, a spring 72 positioned within the detent casing 70, and a detent ball 74 positioned partially within the detent casing 70. In use, the spring 72 biases the detent ball 74 downward to engage one of the detent recesses 64 of the dial 40. When the detent ball 74 engages one of the plurality of detent recesses 64, the rotational resistance of the dial 40 is increased, and thus the orientation of the dial 40 is maintained. To change the orientation of the dial 40, a torque is applied to the dial 40, which moves the detent ball 74 out of one of the detent recesses 64 and into an adjacent detent recess 64. The detent ball 74 is only moveable out of one of the detent recesses 64 if the torque is large enough to overcome the downward biasing force of the spring 72. In other embodiments, more than one spring-loaded detent 68 may be used to maintain the position of the dial 40.

In one exemplary use of the power tool 10, the user moves the multi-position switch 33 along the actuator axis A3 to determine a direction of rotation of the motor of the power tool 10. Next, the user may rotate the dial 40 of the dial assembly 32 in a first direction or a second direction around the dial axis A2 to a new position. When the dial 40 is fully rotated to a new position, the orientation of the magnet 66 is also altered. The Hall effect sensor 52 is configured to detect the magnetic flux of the magnet 66 in the new position and outputs a signal to a controller (see FIG. 6). As the dial 40 is being rotated, the controller can then read a change in magnetic flux measured by the non-contact sensor 52 and accordingly determines a torque setting according to the measured magnetic flux at the new position of the magnet 66. Then, the user may axially displace the trigger 28 along the trigger axis A1 to begin rotation of the motor. In some embodiments, the amount of axial displacement of the trigger 28 is proportional to the rotational speed of the motor. In some embodiments, the dial 40 may be rotated while the trigger 28 is already depressed to adjust the torque setting of the clutch while the motor is in motion. In some embodiments, the user may complete the above steps in any order or may choose to omit one or more steps.

A controller 100 for the power tool 10 is illustrated in FIG. 6. The controller 100 is electrically and/or communicatively connected to a variety of modules or components of the power tool 10. For example, the illustrated controller 100 is connected to indicators 145, a current sensor 170, a speed sensor 150, a temperature sensor 172, secondary sensor(s) 174 (e.g., a voltage sensor, an accelerometer, a torque sensor or torque transducer, etc.), the trigger 28 (via a trigger switch 158), a power switching network 155, and a power input unit 160.

The controller 100 includes a plurality of electrical and electronic components that provide power, operational control, and protection to the components and modules within the controller 100 and/or power tool 10. For example, the controller 100 includes, among other things, a processing unit 105 (e.g., a microprocessor, an electronic processor, an electronic controller, a microcontroller, or another suitable programmable device), a memory 125, input units 130, and output units 135. The processing unit 105 includes, among other things, a control unit 110, an arithmetic logic unit (“ALU”) 115, and a plurality of registers 120 (shown as a group of registers in FIG. 6) and is implemented using a known computer architecture (e.g., a modified Harvard architecture, a von Neumann architecture, etc.). The processing unit 105, the memory 125, the input units 130, and the output units 135, as well as the various modules connected to the controller 100 are connected by one or more control and/or data buses (e.g., common bus 142). The control and/or data buses are shown generally in FIG. 6 for illustrative purposes. The use of one or more control and/or data buses for the interconnection between and communication among the various modules and components would be known to a person skilled in the art in view of the embodiments described herein.

The memory 125 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 105 is connected to the memory 125 and executes software instructions that are capable of being stored in a RAM of the memory 125 (e.g., during execution), a ROM of the memory 125 (e.g., on a generally permanent basis), or another non-transitory computer readable medium such as another memory or a disc. Software included in the implementation of the power tool 10 can be stored in the memory 125 of the controller 100. The software includes, for example, firmware, one or more applications, program data, filters, rules, one or more program modules, and other executable instructions. The controller 100 is configured to retrieve from the memory 125 and execute, among other things, instructions related to the control processes and methods described herein. In other embodiments, the controller 100 includes additional, fewer, or different components.

The controller 100 drives the motor 180 to rotate a driver in response to a user's actuation of the trigger 28. The direction in which the driver rotates the motor 180 corresponds to the current position of the multi-position switch 33. The driver may be coupled to the motor 180 via an output shaft. Depression of the trigger 28 actuates a trigger switch 158, which outputs a signal to the controller 100 to drive the motor 180, and therefore the driver. In some embodiments, the controller 100 controls the power switching network 155 (e.g., a FET switching bridge) to drive the motor 180. For example, the power switching network 155 may include a plurality of high side switching elements (e.g., FETs) and a plurality of low side switching elements. The controller 100 may control each FET of the plurality of high side switching elements and the plurality of low side switching elements to drive each phase of the motor 180. For example, the power switching network 155 may be controlled to more quickly deaccelerate the motor 180. In some embodiments, the controller 100 monitors a rotation of the motor 180 (e.g., a rotational rate of the motor 180, a velocity of the motor 180, a position of the motor 180, and the like) via the speed sensor 150. The motor 180 may be configured to drive a gearbox (e.g., a mechanism). In some embodiments, the controller 100 is configured to implement an electronic clutch. For example, the controller 100 is configured to monitor a current, speed, and/or torque associated with the motor 180. When the monitored current, speed, and/or torque associated with the motor 180 satisfies a threshold value, the controller 100 implements or activates an electronic clutch to reduce or stop operation of the motor 180 (e.g., current to the motor 180 is partially or fully interrupted). In some embodiments, the motor 180 can be pulsed to mimic the sound and feel of a mechanical clutch.

The indicators 145 are also connected to the controller 100 and receive control signals from the controller 100 to turn on and off or otherwise convey information based on different states of the power tool 10. The indicators 145 include, for example, one or more light-emitting diodes (LEDs), or a display screen. The indicators 145 can be configured to display conditions of, or information associated with, the power tool 10. For example, the indicators 145 can display information relating to an operational state of the power tool 10, such as a mode or speed setting. The indicators 145 may also display information relating to a fault condition, or other abnormality of the power tool 10. In addition to or in place of visual indicators, the indicators 145 may also include a speaker or a tactile feedback mechanism (e.g., motor 180) to convey information to a user through audible or tactile outputs. In some embodiments, the indicators 145 display information related to a braking operation or a clutch operation (e.g., an electronic clutch operation) of the controller 100. For example, one or more LEDs are activated when the controller 100 is performing a clutch operation.

A battery pack interface 185 is connected to the controller 100 and is configured to couple with a battery pack 190. The battery pack interface 185 includes a combination of mechanical (e.g., a battery pack receiving portion) and electrical components configured to and operable for interfacing (e.g., mechanically, electrically, and communicatively connecting) the power tool 10 with the battery pack 190. The battery pack interface 185 is coupled to the power input unit 160. The battery pack interface 185 transmits the power received from the battery pack 190 to the power input unit 160. The power input unit 160 includes active and/or passive components (e.g., voltage step-down controllers, voltage converters, rectifiers, filters, etc.) to regulate or control the power received through the battery pack interface 185 and to the controller 100. In some embodiments, the battery pack interface 185 is also coupled to the power switching network 155. The operation of the power switching network 155, as controlled by the controller 100, determines how power is supplied to the motor 180.

The current sensor 170 senses a current provided by the battery pack 190, a current associated with the motor 180, or a combination thereof. In some embodiments, the current sensor 170 senses at least one of the phase currents of the motor. The current sensor 170 may be, for example, an inline phase current sensor, a pulse-width-modulation-center-sampled inverter bus current sensor, or the like. The speed sensor 150 senses a speed of the motor 180. The speed sensor 150 may include, for example, one or more Hall effect sensors. In some embodiments, the temperature sensor 172 senses a temperature of the switching network 155, the battery pack 190, the motor 180, or a combination thereof.

The input device 140 is operably coupled to the controller 100 to, for example, set a desired torque and/or a desired speed value at which to drive the motor 180. In some embodiments, the input device 140 is configured as a ring (e.g., torque ring) or the torque adjustment interface (e.g., the dial assembly 32). In other embodiments, the input device 140 includes a combination of digital and analog input or output devices required to achieve a desired level of operation for the power tool 10, such as one or more knobs, one or more dials, one or more switches, one or more buttons, etc.

The power tool 10 can include a variety of different types of indicators to indicate, for example, different torque settings for the power tool 10 that are set using a torque adjustment interface (e.g., the dial assembly 32). In some embodiments, a torque setting indicator can be located on an upper or top portion of the power tool 10. In some embodiments, the torque setting indicator can be located on a side portion (e.g., a rear side portion) of the power tool 10.

Although the disclosure has been described in detail with reference to certain embodiments, variations and modifications exist within the scope and spirit of one or more independent aspects of the disclosure as described. Various features and advantages are set forth in the following claims.

What is claimed is:

1. A power tool comprising:
a housing including a motor housing portion and a handle portion extending from the motor housing portion;
a motor within the motor housing portion;
a trigger located on a front side of the handle portion, the trigger moveable axially along a trigger axis; and
a dial assembly partially positioned within the housing above the trigger, the dial assembly configured to change an operational characteristic of the power tool, the dial assembly including:
a dial rotatable about a dial axis orthogonal to the trigger axis, the dial including a magnet aperture,
a magnet coupled to the dial, the magnet rotatable with the dial, and
a dial circuit board including a non-contact sensor configured to generate a signal representative of an orientation of the magnet.

2. The power tool of claim 1, wherein the dial assembly further includes a case coupled to the housing, wherein:
the case is surrounded by the dial;
the case houses the dial circuit board;
the case further includes a recess formed on an outer circumference; and
the recess is configured to receive an O-ring.

3. The power tool of claim 1, wherein the operational characteristic that the dial assembly is configured to change is a torque setting of the power tool.

4. The power tool of claim 1, wherein:
the non-contact sensor is a Hall effect sensor positioned in a center of the dial circuit board in line with the magnet in the magnet aperture of the dial; and
the non-contact sensor is a digital 3-Dimensional (“3D”) Hall effect sensor configured to measure a magnetic flux of the magnet.

5. The power tool of claim 1, wherein:
a spring-loaded detent is positioned within the housing and contacts a top surface of the dial; and
the spring-loaded detent is configured to increase a rotational resistance of the dial.

6. The power tool of claim 5, wherein the top surface of the dial includes a plurality of recesses configured to receive a portion of the spring-loaded detent.

7. The power tool of claim 1, wherein the magnet aperture of the dial is in line with the dial axis.

8. The power tool of claim 1, further comprising:
a multi-position switch moveable axially along an actuator axis,
wherein the dial axis is orthogonal to the trigger axis and the actuator axis.

9. The power tool of claim 1, wherein the dial circuit board has a substantially circular profile.

10. A power tool comprising:
a housing;
a motor within the housing;
a trigger moveable axially along a trigger axis; and
a dial assembly partially positioned within the housing, the dial assembly configured to change an operational characteristic of the power tool, the dial assembly including:
a dial rotatable about a dial axis orthogonal to the trigger axis, the dial including:
a magnet coupled to the dial, the magnet rotatable with the dial, and
a dial circuit board including a non-contact sensor configured to generate a signal representative of an orientation of the magnet.

11. The power tool of claim 10, wherein the operational characteristic that the dial assembly is configured to change is a torque setting of the power tool.

12. The power tool of claim 10, wherein the non-contact sensor is a Hall effect sensor.

13. The power tool of claim 10, wherein:
a spring-loaded detent is positioned within the housing and contacts a top surface of the dial; and
the spring-loaded detent is configured to increase a rotational resistance of the dial.

14. The power tool of claim 13, wherein the top surface of the dial includes a plurality of recesses configured to receive a portion of the spring-loaded detent.

15. The power tool of claim 10, further comprising:
a multi-position switch moveable axially along an actuator axis,
wherein the dial axis is orthogonal to the trigger axis and the actuator axis.

16. The power tool of claim 10, wherein the dial circuit board has a substantially circular profile.

17. A power tool comprising:
a housing;
a motor within the housing;
a trigger for activating the motor; and
a dial assembly partially positioned within the housing, the dial assembly configured to change an operational characteristic of the power tool, the dial assembly including:
a dial rotatable about a dial axis, the dial including:
a magnet coupled to the dial, the magnet rotatable with the dial, and
a non-contact sensor configured to generate a signal representative of an orientation of the magnet.

18. The power tool of claim 17, wherein the operational characteristic that the dial assembly is configured to change is a torque setting of the power tool.

19. The power tool of claim 17, wherein the non-contact sensor is a Hall effect sensor.

20. The power tool of claim 17, further comprising:
a multi-position switch moveable axially along an actuator axis,
wherein the dial axis is orthogonal to the actuator axis.
